(19) United States
(12) Patent Application Publication
(10) Pub. No.: US 2026/0099834 A1
(43) Pub. Date: Apr. 9, 2026

(54) SYSTEMS AND METHODS FOR SECURE ACTIVATION OF PREPAID CARDS

(71) Applicant: Fiserv, Inc., Milwaukee, WI (US)

(72) Inventors: Denielle Denise Savage, Omaha, NE (US); Kenneth Eugene Jennings, JR., Davie, FL (US); Christopher Douglas Ruisi, Middleton, DE (US)

(73) Assignee: Fiserv, Inc., Milwaukee, WI (US)

(21) Appl. No.: 18/975,384

(22) Filed: Dec. 10, 2024

Related U.S. Application Data
(60) Provisional application No. 63/703,056, filed on Oct. 3, 2024.

(51) Int. Cl. G06Q 20/34

(52) U.S. Cl. CPC G06Q 20/354; G06Q 20/357

(57) ABSTRACT

Implementations and examples described herein provide for prepaid gift cards, and processing of prepaid gift cards, having security measures to prevent fraudulent redemption of the prepaid gift cards.

### CROSS-REFERENCE TO RELATED APPLICATIONS

This application claims priority to U.S. Provisional Application No. 63/703,056 filed Oct. 3, 2024, which application is incorporated herein in its entirety.

### BACKGROUND

Prepaid cards (e.g., “gift cards”) can be loaded with funds and activated for use in transactions. Once activated, such cards can be used similar to cash and may be targeted by fraudsters. Gift cards are often displayed at point-of-sale devices such as at supermarket checkout stands or restaurant cashier stands. Conventionally, one or more gift cards are sold in a single package. These gift cards are often activated by swiping or scanning them at the checkout stand at which point the card number (account number) is referred to a computer which activates the card's account.

Conventional prepaid cards generally have an account number that can be used to determine a current available balance. A fraudster may access the account number of one or more cards that are displayed prior to purchase of the card by a consumer and activation at a point of sale (sometimes referred to as “skimming”). The fraudster may periodically query a balance of the prepaid card using the account number(s). If the fraudster determines that there is non-zero balance associated with the card, the fraudster will be alerted that the card has been activated and then use the account number to perform a transaction before the legitimate purchaser can use the prepaid card. This security difficulty arises due to the anonymous nature of prepaid cards. As it is not known who will use the prepaid card, any person with the correct information (account number) can use the prepaid card. Additional details on prepaid cards are disclosed in U.S. Pat. No. 7,822,640, which is incorporated herein by reference in its entirety.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

Aspects of the present disclosure are directed to a prepaid card including an account number for performing transactions and an activation number for activating the prepaid card, where the activation number is accessible before and during activation of the prepaid card, and the account number is not accessible until after activation of the prepaid card.

Aspects of the present disclosure are directed to a method for activating a prepaid card having an account number and an activation number, the method including receiving, from a point-of-sale (POS) device, by a prepaid card server, the activation number, identifying the account number based on an association between the account number and the activation number, activating the account number for use in transactions, and transmitting an activation message to the POS device.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is an example block diagram of system for activating prepaid cards having activation numbers.

FIG. 2 illustrates example details of the prepaid card database of FIG. 1.

FIG. 3 illustrates security features of a prepaid card without an activation number.

FIG. 4 illustrates an example process for activating the prepaid card of FIG. 3.

FIG. 5 illustrates security features of a prepaid card having an activation number.

FIG. 6 illustrates an example process for activating the prepaid card of FIG. 5.

FIG. 7 illustrates an example bundle of multiple prepaid cards sharing a single activation number.

FIG. 8 illustrates an example prepaid card packaged inside a packaging having an activation number.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

Aspects of the present disclosure relate to providing and activating one or more physical prepaid transaction cards (e.g., gift cards) that include an activation number and an account number. The activation number can be used to activate the prepaid card(s), and the account number can be used to perform transactions using the prepaid card. By using a separate number for activating the prepaid card, fraud can be prevented.

To prevent fraud, the activation number is accessible prior to activation, but the account number(s) associated with the physical prepaid card(s) is (are) concealed. For example, the account number(s) of the card(s) may be concealed by packaging containing the card(s), or a physical prepaid card may have a tamper-evident security label that bears the activation code. Thus, fraudsters who attempt to collect account numbers of prepaid cards prior to activation in order to use the funds of the prepaid cards after activation will only be able to collect the activation number, which cannot be used to perform transactions. Implementations and examples described herein solve the technical problem of securing prepaid cards by separating the accessible activation number that can be used for activating the prepaid card from the non-accessible account number that can be used to perform transactions. In this way, the prepaid card can be activated without risk of the account number being compromised.

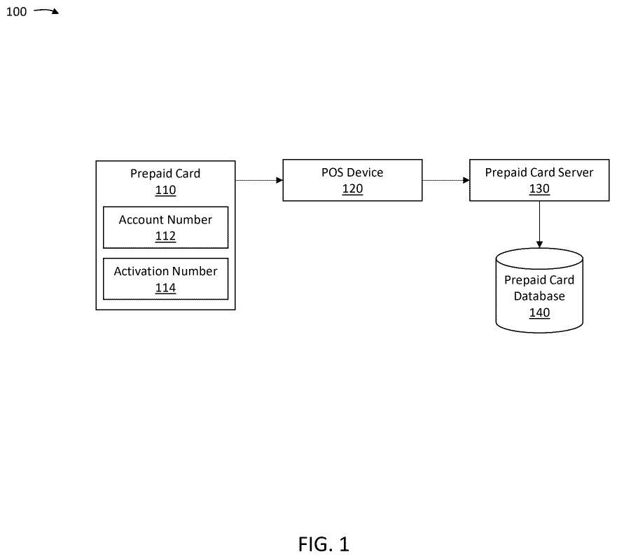

FIG. 1 is an example block diagram of system 100 for activating prepaid cards having activation numbers. The system 100 includes a prepaid card 110 including an account number 112 and an activation number 114, a point-of-sale device 120, a prepaid card server 130, and a prepaid card database 140.

The account number 112 is not visible on the prepaid card 110 prior to activation and the activation number 114 is visible on the prepaid card 110 prior to activation of the prepaid card 110. The account number 112 is used for conducting transactions using the prepaid card 110 after activation of the prepaid card 110 and the activation number 114 is used only for activating the prepaid card 110. As the activation number 114 is visible on the prepaid card 110 prior to activation, but the account number 112 is not, the activation number 114 can be accessed and used for activation, but the account number 112 cannot be accessed. In some implementations, the activation number 114 is not visible on the prepaid card 110 but is accessible to the POS device 120. In an example, the activation number 114 is encoded in a bar code or magnetic stripe of the prepaid card 110.

The POS device 120 receives the activation number 114. In some implementations, the activation number 114 is concealed behind a removable covering, such as a scratch-off concealer, sticker, label, or other tamper-evident seal. In some implementations, the activation number 114 is visible on the prepaid card 110. In some implementations, the activation number 114 is encoded in a bar code and/or magnetic stripe of the prepaid card 110. The POS device 120 transmits the activation number 114 to the prepaid card server 130 to activate the prepaid card. The prepaid card server 130 queries the prepaid card database 140 to determine that the account number 112 is associated with the activation number 114. The prepaid card server 130, based on the association between the account number 112 and the activation number 114, activates the account number for use in transactions. In some implementations, the prepaid card database 140 is part of the prepaid card server 130. In some implementations, the POS device 120 may transmit an amount to be loaded onto the prepaid card 110 to the prepaid card server 130.

The prepaid card server 130 transmits an activation approval to the POS device 120 indicating that the prepaid card 110 is activated. At this time, the account number 112 is still not visible, and can be revealed by the customer who purchased the prepaid card 110 or a recipient of the prepaid card 110. The account number 112 can be used to execute transactions, including in-person and online transactions. The activation number 114 is associated only with activation and cannot be used to execute transactions. In some implementations, the activation number 114 has a same format as the account number 112 and appears to be an account number. In this way, attempted fraud can be detected by detecting balance inquiries on the activation number 114. In some implementations, balance queries on the activation number 114 are responded to by the prepaid card server 130 with a response of zero balance, preventing fraudsters from learning that the prepaid card 110 was activated while allowing the prepaid card server 130 to detect attempted fraud. The balance query on the activation number 114 indicates potential or attempted fraud, as the activation number 114 cannot be used for performing transactions and is not associated with a balance.

Maintaining the account number 112 hidden before and during activation can prevent fraud. As the account number 112 is hidden, or inaccessible before and during activation of the prepaid card 110, a fraudster cannot attempt to use the account number 112 for transactions after the prepaid card 110 is activated. Using the activation number 114, which is accessible before and during activation, for activating the prepaid card 110 and using the account number 112 for executing transactions separates the activation and use of the prepaid card 110, solving the technical problem maintaining security of prepaid cards that are not linked to any person's identity.

In some implementations, the activation number 114 is an activation token that may include numbers, letters, and/or other characters.

During activation of the prepaid card 110, the POS device 120 receives the activation number 114. The POS device 120 can receive the activation number 114 by scanning a bar code in which the activation number 114 is encoded, by swiping a magnetic strip in which the activation number 114 is encoded, by manually entering the activation number 114, or by another method. The POS device 120 may determine that the activation number 114 is an activation number and generate an activation request including the activation number 114 to send to the prepaid card server 130. In an example, the POS device 120 queries a product list for the activation number 114 that indicates that the activation number 114 is an activation number. In an example, the POS device 120 calculates a checksum using the activation number 114 to determine whether the activation number 114 is a valid activation number. The activation request can include an amount of funds to be added to the prepaid card 110. In an example, the activation request includes an amount of funds a purchaser is loading onto the prepaid card 110. In an example, the prepaid card is sold as being loaded with a predetermined amount of funds, and the activation request does not include the amount of funds, the amount of funds being already stored in the prepaid card database 140.

The POS device 120 receives an activation message from the prepaid card server 130 in response to the activation request and completes the transaction. The POS device 130 may indicate that the prepaid card 110 has been activated and can generate a receipt indicating that the prepaid card 110 has been activated.

During execution of a transaction using the prepaid card 110, the POS device 130 receives the account number 112. The POS device 120 can receive the account number 112 by scanning a bar code in which the account number 112 is encoded, by swiping a magnetic strip in which the account number 112 is encoded, by manually entering the account number 112, or by another method. The POS device 120 generates an authorization request including an amount of funds to be released and sends the authorization request to the prepaid card server 130. The POS device 120 receives an indication of an amount of funds to be applied to the transaction and completes the transaction. In an example, the balance of the prepaid card 110 is sufficient to complete the transaction. In an example, the balance of the prepaid card 110 is insufficient to complete the transaction and additional funds are required.

During activation of the prepaid card 110, the prepaid card server 130 receives the activation request from the POS device 120 including the activation number 114. The prepaid card server 130 updates the prepaid card database 140 to activate the account number 112 of the prepaid card 110 in response to the activation request. The prepaid card database 130 can query the prepaid card database 140 to identify the account number 112 using the activation number 114 in order to activate the account number 112. The prepaid card server 130 transmits an activation message to the POS device 120 indicating that the prepaid card 110 is activated.

During execution of a transaction using the prepaid card 110, the prepaid card server 130 receives the authorization request from the POS device 120, 130 checks a balance of the prepaid card 110 in the prepaid card database 140, and transmits a transaction indication to the POS device 120. The transaction indication can include an amount of funds to be applied to the transaction. Upon successful completion of the transaction, the prepaid card server 130 receives from the POS device 120 an indication of transaction completion. In an example, the prepaid card server 130 locks a portion of the balance of the prepaid card 110 in the prepaid card database 140, sends an indication of the locked portion of the balance to the POS device 120, and subtracts the locked portion of the balance in response to receiving the indication of transaction completion from the POS device 120.

In some implementations, the activation number 114 is treated as another prepaid card in the prepaid card database 140 such that the activation number 114 can be used within existing data structures and API requests, such as balance inquiries. The activation number 114 may be associated with the account number 112 in the prepaid card database 140. The combination of the activation number 114 and the account number 112 of the single prepaid card 110 can be referred to as a “package.” A package can include one activation number 114 and multiple account numbers, as discussed herein.

In some implementations, the prepaid card server 130 can activate prepaid cards having an activation number and prepaid cards without an activation number. The prepaid card server 130 can determine, when an activation request is received, by the account number field in the request, an indication of a type of card as secure or not, whether the prepaid card 110 is being activated using an account number or an activation number. In some implementations, the prepaid card server 130 can treat activation numbers and account numbers as separate “cards.” In an example, when an Activation Transaction is received from the POS device 120, the prepaid card server 130 will verify the card's Secure Card Type. If the Secure Card Type is “N,” (e.g., normal) indicating that the card is not from a secure package, the transaction will proceed as per the existing transaction flow. If the Secure Card Type is either “S” (e.g., single) or “M,” (e.g., multi) the incoming activation transaction will be declined (e.g., rejection notification) with an Invalid Transaction Code, as account numbers corresponding to the secure card types S and M cannot be used in activating cards, such as the account number 112. If the Secure Card Type is T, indicating that the “card” is an activation number from a secure package, the prepaid card server 130 will activate all the cards from the secure package. In an example, one card is in the package, and the prepaid card server 130 activates the one card. In an example, multiple cards are in the package, and the prepaid card server 130 activates all of the multiple cards in the package.

In the event that multiple cards are in the package, the prepaid card server 130 determines whether the activation number is already present in the account table and includes a non-zero package ID and then the prepaid card server 130 will fetch all the card numbers belonging to that package ID in the MULTI_PACK table and process the activation transaction one by one for each card. However, if the account entry is absent in the account table, then the prepaid card server 130 will query the MULTI_PACK table using the incoming card number and retrieve the package ID to which the card belongs. When the prepaid card server 130 acquires the package ID it will again query the MULTI_PACK table using the package ID to obtain the list of cards that belong to the package. the prepaid card server 130 will process the activation transaction on each card present in that package. If the account entry is absent in the account table as well as the manufacture table, then the incoming transaction will be declined with Unknown account.

The Activation transaction for a package is required to be successful for all the cards in the secure package. Any failure to activate any card in the package means complete failure of the entire secure package activation request which will be declined with the external response error code of the failure. The cards already processed successfully will be rolled back and reported as declined transactions. Cards in the package that were not yet processed for activation due to the failure will have Activation transactions created as declined.

Successful Activation transactions will return previous balance as 0 (zero) and new balance as the value of the package amount (the amount value sent in the original request). The value of the package is expected to reflect the value of the purchased cards in the package and exclude any Bonus cards. In the prepaid card database 140, each card's individual activation transaction will instead show the real activation amount for that specific card, and the balance will be the same as the individual card's activation amount.

In some implementations, the prepaid card server 130 must verify that the requested card number is the FIRST card number in the package. The cards are manufactured in sequential order, so the numerically lowest serial number for the package ID which is an activation number is the first card number in the Secure package. If the request card is NOT the FIRST card in the package, then the transaction will be declined. Here, the activation number will act as a carrier transaction only, holding no value. Upon receiving the activation request on the activation number, the associated normal cards or multi-pack cards from the secure package will be activated with the incoming transaction's value, following the existing functionality. The activation number will be recorded in a transaction log with a transaction amount of zero. The associated normal card/multi pack will function as per current protocol and will get recorded against the transaction log as per properties present against incoming transactions. Both activation number as well as Normal Card will have transaction ID and ALT ID as an activation ID and transacting MID against the transaction log.

In some implementations, upon successful activation, the activation number 114 will move to CLOSE Status in the prepaid card database 140.

If a card in an incoming request for information transaction request belongs to a Secure package and the card is present in the account table without a package ID, then the prepaid card server 130 will retrieve the package id from the MULTI_PACK table for the requested card. If the prepaid card server 130 acquires a package ID, then it will again query the MULTI_PACK table using the package ID to retrieve the list of all the cards in the same package. the prepaid card server 130 will update the package ID value in the account table for those cards.

If the card in the incoming transaction request belongs to a Secure package and the card is not present in the account table, then the prepaid card server 130 will retrieve the package ID from the MULTI_PACK table for the requested card. If the prepaid card server 130 acquires a package ID, then it will again query the MULTI_PACK table using the package ID to retrieve the list of all the cards in the same package. the prepaid card server 130 will dynamically allocate an Inactive account record for each card belonging to the package and populate the package ID in each account record.

On receiving a balance inquiry against an activation number (e.g., the activation number 114) from the secure package, the response will always be successful, indicating an account balance of ZERO and a card status of ACTIVE. In this way, fraudsters attempting to determine when cards are activated by querying balances will not be able to see when the prepaid card 110 is activated, as the balance associated with the activation number 114 is always zero, and the card status is always active.

On receiving any transaction other than a balance inquiry and activation against an activation number from the secure package, the response will be DECLINE. In an example, the response includes a rejection notification in response to a transaction request. In this way, the activation number 114 cannot be used for executing transactions and can only be used to activate the prepaid card 110.

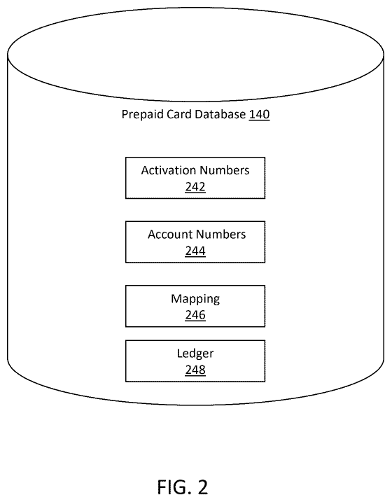

FIG. 2 illustrates example details of the prepaid card database 140 of FIG. 1. The prepaid card database 140 can include activation numbers 242, account numbers 244, a mapping 246, and a ledger 248. The activation numbers 242 can include activation numbers 242 for prepaid cards that have been created and that may or may not be activated. The activation numbers 242 may be activation tokens including numbers, letters, and/or other characters. The account numbers 244 can include account numbers 244 for prepaid cards that have been created and that may or may not be activated. The activation numbers 242 and the account numbers 244 can be included on prepaid cards in pairs such that a prepaid card includes an activation number of the activation numbers 242 and an account number of the account numbers 244, such as the prepaid card 110 of FIG. 1. The mapping 246 can map the activation numbers 242 to the account numbers 244. The mapping 246 can map a single activation number of the activation numbers 242 to a single account number of the account numbers 244. The mapping 246 can map a single activation number of the activation numbers 242 to multiple account numbers of the account numbers 244.

When a prepaid card is created, data records for the prepaid card are created in the activation numbers 242, the account numbers 244, and the mapping 246 to give the prepaid card an activation number and an associated account number. In the event the prepaid card is a physical card, the prepaid card is printed, embossed, or otherwise manufactured to include the activation number and the account number. The prepaid card is manufactured such that the activation number is accessible and the account number is not accessible. In this way, the prepaid card can be activated using the activation number without allowing access to the account number. Once the prepaid card is activated, funds can be added to the account number. The ledger 248 can store an amount of funds associated with the account numbers 244. After activation of the prepaid card, the activation number can be made accessible, allowing for execution of transactions using the account number.

When the prepaid card is used to execute a transaction, the account number can be used in a conventional manner to execute the transaction. The prepaid card database 140 can be queried to determine an amount of funds associated with the account number to execute the transaction.

In some implementations, the activation numbers 242, the account numbers 244, the mapping 246, and the ledger 248 are separate data structures. In some implementations, one or more of the activation numbers 242, the account numbers 244, the mapping 246, and the ledger 248 are included in a common data structure. The illustrated example is provide for illustrative purposes only, and other data structures are contemplated. In an example, a multipack data structure may be used to track prepaid cards that are included in bundles of multiple prepaid cards, where all of the cards in the bundle are activated using a single activation number. In an example, a bonus cards data structure may be used to track bonus cards that are included in packing including purchased cards, where the bonus cards are automatically activated upon activation of the purchased cards.

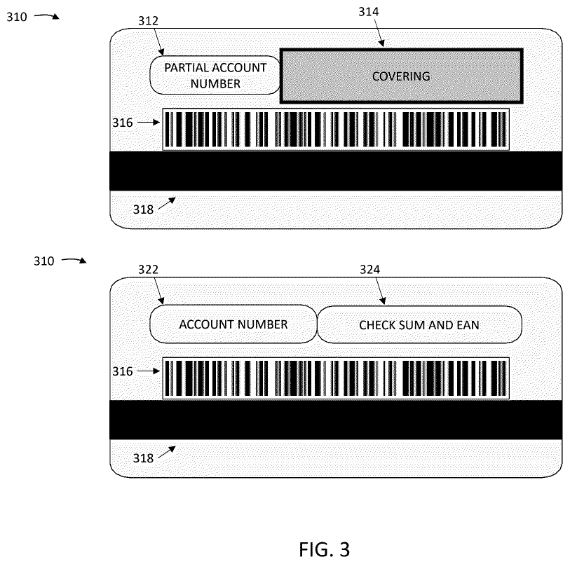

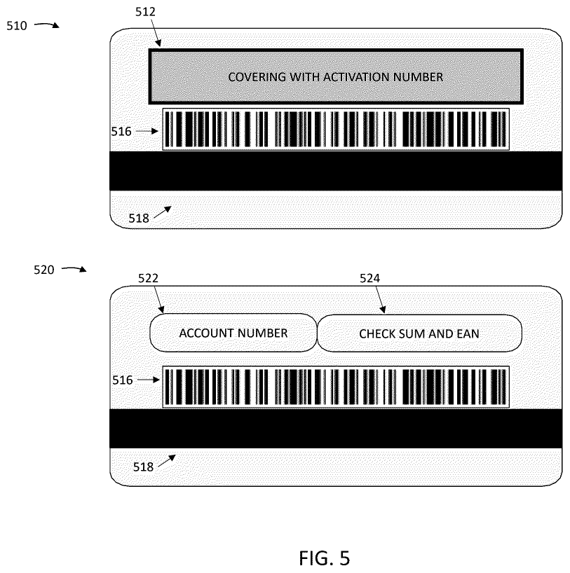

FIG. 3 illustrates security features of a prepaid card without an activation number. The prepaid card 310, prior to activation, includes a covering 314 such that a portion of an account number 322 and a check sum and extended account number (EAN) 324 are covered. By covering a portion of the account number 322, only a partial account number 312 is visible on the prepaid card 310 prior to activation. The prepaid card 310 includes a bar code 316 and a magnetic stripe 318. In some implementations, the account number 322 can be encoded in the bar code 316 and/or the magnetic stripe 318. When a person purchases the prepaid card 310, a cashier can scan the barcode 316 or swipe the magnetic stripe 318 to obtain the account number 322 to activate the prepaid card 310. The covering 314 can prevent a fraudster from reading the account number 322. However, a fraudster might scan the barcode 316, swipe the magnetic stripe 318, and/or tamper with the covering 314 to obtain the account number 322. Once a fraudster has the account number 322 and/or check sum and EAN 324, the fraudster can query the balance of the prepaid card 310 to determine when the prepaid card 310 has been activated. The fraudster can fraudulently redeem the prepaid card 310 prior to the legitimate owner using the account number 322. A prepaid card having an activation number that is separate from the account number, such as illustrated in FIG. 5, has greater security than the prepaid card 310.

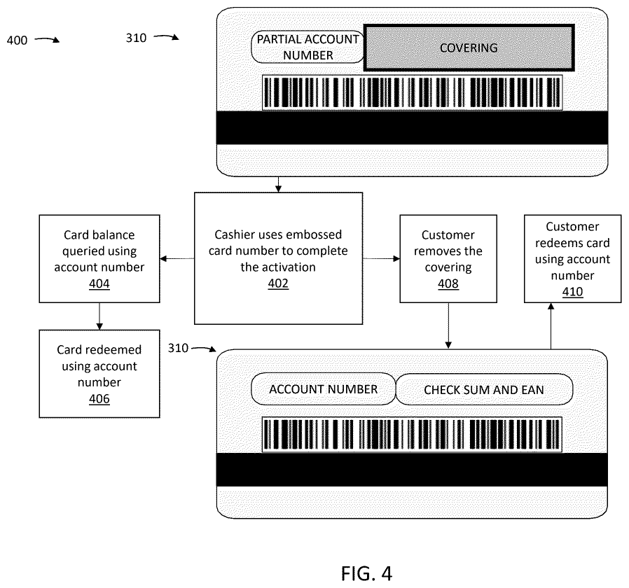

FIG. 4 illustrates an example process 400 for activating the prepaid card 310 of FIG. 3. The process 400 may include more, fewer, or different operations than shown. The operations can be performed in the order shown, in a different order, or concurrently. At operation 402, a cashier scans the prepaid card 310 and activates the prepaid card 310. In some implementations, an unauthorized individual has previously scanned the prepaid card 310 and/or tampered with the covering and is monitoring a balance of the prepaid card 310 to determine when it is activated. At operation 404, the unauthorized individual queries the balance of the prepaid card 310 to see whether the prepaid card 310 has been activated. When the unauthorized individual sees a non-zero balance, the unauthorized individual knows that the prepaid card 310 has been activated. At operation 406, the unauthorized individual redeems (e.g., spends the funds of) the prepaid card 310 using the account number. At operation 408, the customer, or card recipient, removes the covering from the prepaid card 310. At operation 410, the customer, or card recipient, redeems the card using the account number. If the unauthorized individual redeemed the prepaid card 310 (operation 406) at any point before the customer or card recipient redeemed the prepaid card 310 (operation 410), the customer or card recipient will see that the prepaid card 310 has a reduced (e.g., zero) balance.

FIG. 5 illustrates security features of a prepaid card 510 having an activation number. The prepaid card 510 includes a covering 512 that includes the activation number, a bar code 516, and a magnetic stripe 518. The covering covers the account number 522 and the check sum and EAN 524 of the prepaid card 510. In this way, the covering 512 makes the activation number accessible prior to activation and makes the account number 522 inaccessible prior to activation. Additionally, by including the activation number on the covering 512, the activation number is removed if a fraudster attempts to tamper with the covering 512 to view the account number 522, as removal of the covering 512 removes the activation number, or otherwise renders the activation number unreadable. If the activation number is removed by a fraudster attempting to get the account number 522 and/or the check sum and EAN 524, the prepaid card 510 cannot be activated.

The bar code 516 and/or the magnetic stripe 518 may encode the activation number. Thus, when a cashier scans the bar code 516 or swipes the magnetic stripe 518, the activation number can be used to activate the prepaid card 510. However, when a fraudster scans the bar code 516 or swipes the magnetic stripe 518, the fraudster can neither activate the prepaid card (e.g., lacking API permissions to send activation requests) nor query the balance of the prepaid card. As discussed herein, the activation number is only used for activation of the prepaid card 510, not transactions. Thus, if a fraudster attempts to query a balance of the prepaid card 510 using the activation number, the balance will be returned as zero, or invalid whether or not funds have been loaded on the prepaid card 510. Thus, a fraudster cannot monitor a balance associated with the activation number, as the activation number is not associated with the actual balance of the prepaid card 510.

In some implementations, the account number 522 is encoded in a second bar code, allowing for scanning of the account number 522 for execution of transactions using the account number 522. In some implementations, the account number 522 and check sum and EAN 524 are encoded in the second bar code for execution of transactions.

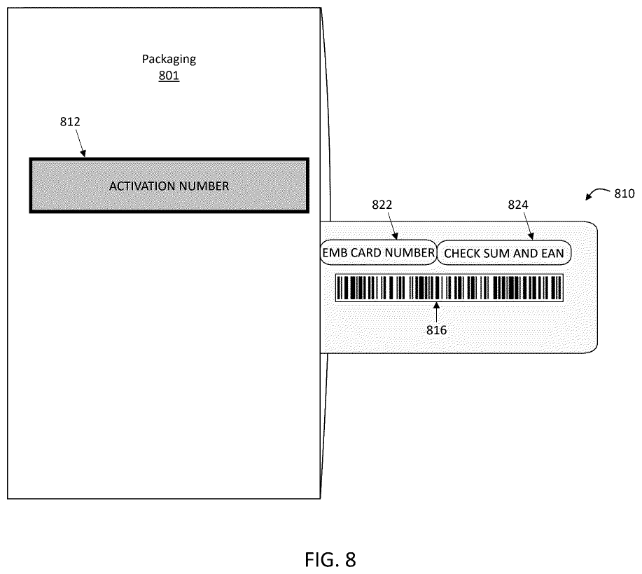

In some implementations, the covering 512 is not located on the prepaid card 510, but is a packaging of the prepaid card 510, where the packaging includes the activation number, as illustrated in FIG. 8. In an example, the packaging of the prepaid card 510 conceals the prepaid card 510, or a portion of the prepaid card 510 including the account number 522, and the packaging includes the activation number.

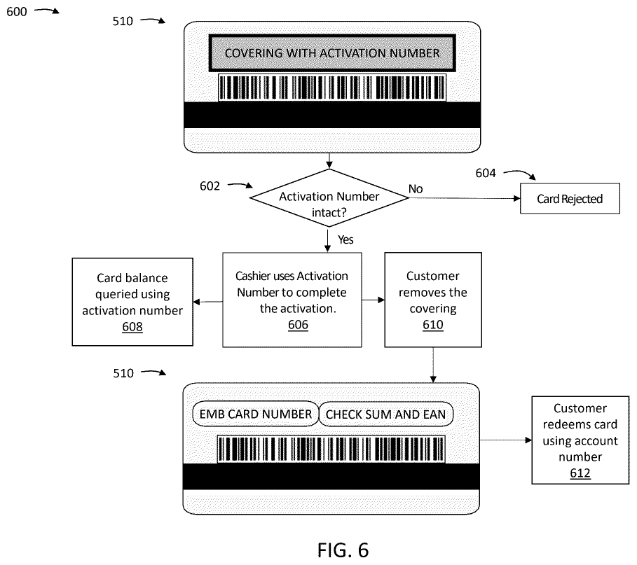

FIG. 6 illustrates an example process 600 for activating the prepaid card 510 of FIG. 5. The process 600 may include more, fewer, or different operations than shown. The operations can be performed in the order shown, in a different order, or concurrently. At operation 602, the cashier checks whether the activation number (e.g., covering including the activation number) is intact. If the activation number is not intact, the prepaid card 510 cannot be activated, and the prepaid card 510 is rejected at operation 604.

At operation 606, a cashier scans the prepaid card 510 and uses the activation number to activate the prepaid card 510. At operation 608, a unauthorized individual queries a balance of the prepaid card 510 using the activation number obtained by scanning the prepaid card 510. However, as the activation number is not associated with the balance of the prepaid card 510, the balance, if any, of the activation number does not change when the prepaid card 510 is activated and so the unauthorized individual does not know when the prepaid card 510 has been activated. At operation 610, a customer removes the covering 610 and can use the account number 522 of the prepaid card 510 at operation 612 to redeem the prepaid card 510. By using separate numbers (e.g., tokens) for activation and transactions, the security measures of the prepaid card 510 prevent fraud.

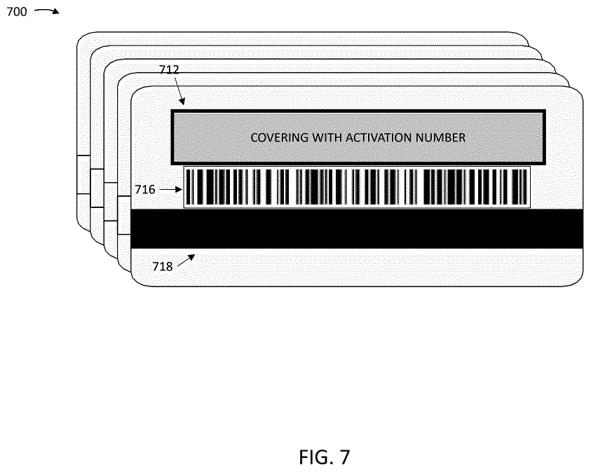

FIG. 7 illustrates an example bundle 700 of multiple prepaid cards sharing a single activation number. The bundle 700 may include any number of prepaid cards. The prepaid cards in the bundle 700 may each have their own account number that can be loaded with funds and separately used for executing transactions. In an example, the bundle 700 includes five $50 gift cards, where each gift card is loaded with $50 and can be used separately for executing transactions. The prepaid cards in the bundle 700 may each include a covering 712 including the activation number. The activation number can also be encoded in a bar code 716 or magnetic stripe 718 of each of the prepaid cards. The activation number can be associated with all of the prepaid cards in the bundle 700 (i.e., with all of the account numbers of the cards in the bundle 700) such that the activation number is used to activate all of the prepaid cards in the bundle 700. In an example, the activation number is associated with all of the account numbers of the bundle 700 in the mapping 246 of FIG. 2. In an example, a single activation request including the activation number activates all of the prepaid cards in the bundle 700.

In some implementations, only a first prepaid card of the bundle includes the activation number, allowing for the activation number to be scanned and the activation request for all of the prepaid cards in the bundle 700 to be sent to activation the prepaid cards of the bundle 700. In some implementations, a packaging of the bundle 700 includes the activation number. In an example, the prepaid cards in the bundle 700 are not visible and do not include the activation number, but the packaging of the bundle 700 includes the activation number.

FIG. 8 illustrates an example prepaid card 810 packaged inside a packaging 801 having an activation number 812. The prepaid card 810 includes a bar code 816, an account number 822, and a check sum and EAN 822. The prepaid card 810 may be similar to the prepaid card 310 of FIG. 3 and the prepaid card 510 of FIG. 5, except that the prepaid card 810 does not include a covering. In some implementations, the prepaid card 810 does not include a magnetic stripe. The prepaid card 810 is packaged within the packaging 801 and the prepaid card 810 is not visible, or the bar code 816, the account number 822, and/or the check sum and EAN 822 are not visible. In this way, the packaging 801 conceals the information on the prepaid card 810 and functions as a covering for the information on the prepaid card 810. In some implementations, the prepaid card 810 includes coverings similar to the prepaid card 310 of FIG. 3 and the prepaid card 510 of FIG. 5. In this way, the packaging 801 can be used with any type or configuration of prepaid card to provide activation security.

The packaging 801 includes an activation number 812. The activation number 812 can be used to activate the prepaid card 810, but cannot be used for transactions, and the account number 822 can be used for transactions, but not to activate the prepaid card 810. In this way, the activation number 812 can be displayed without concealment on the packaging 801 with the prepaid card 810 concealed within the packaging, providing efficient access to the activation number 812 while preserving a security of the prepaid card 810. The activation number 812 and the account number 822 can be stored in the prepaid card database 140 of FIG. 1. The activation number 812 and the account number 822 can be stored in the activation numbers 242 and the account numbers 244, respectively, of the prepaid card database 140. Activation and use of the prepaid card can be performed as described in the method 600, as discussed herein. Thus, the packaging 801 provides a system for providing activation security, similar to the covering with activation number 512 of FIG. 5.

As described herein, the packaging 801 can be used to conceal (e.g., envelop, contain) any type of prepaid card. Similarly, the packaging can be used to conceal a bundle of prepaid cards such as the bundle 700 of FIG. 7. In this way, the activation number 812 on the packaging 801 can be used to activate any number of cards included in the packaging 801.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,”etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A system comprising:
a prepaid card including an account number that is not accessible prior to activation of the prepaid card, wherein the account number can be used, after the activation of the prepaid card, to perform transactions using the prepaid card and cannot be used to activate the prepaid card; and
a covering concealing at least a portion of the prepaid card, the covering including an activation token that is accessible prior to activation of the prepaid card, wherein the activation token can be used to activate the prepaid card and cannot be used to perform transactions using the prepaid card.

2. The system of claim 1, wherein the covering comprises a tamper-evident seal attached to the prepaid card, wherein removal of the tamper-evident seal renders the activation number unreadable, and wherein the covering conceals at least a portion of the account number to cause the account number to not be accessible prior to activation of the prepaid card.

3. The system of claim 1, wherein a balance query including the activation token returns a response including a balance that is not a balance of the prepaid card.

4. The system of claim 3, wherein the balance query including the activation token indicates attempted fraud.

5. The system of claim 1, wherein the covering comprises a packaging within which the prepaid card is packaged, wherein the packaging conceals at least a portion of the account number to cause the account number to not be accessible prior to activation of the prepaid card.

6. The system of claim 5, wherein the packaging contains a plurality of prepaid cards, and wherein the plurality of prepaid cards can be activated using the activation token.

7. A method comprising:
receiving, at a prepaid card server, from a point-of-sale (POS) device, an activation request for a prepaid card, the activation request including an activation token;
identifying, by the prepaid card server, using a mapping of activation tokens to account numbers, an account number associated with the activation token;
updating, by the prepaid card server, a status of the account number to activate the prepaid card; and
transmitting, by the prepaid card server, to the POS device, an activation message indicating activation of the prepaid card.

8. The method of claim 7, wherein identifying the account number includes querying, using the activation token, a database including the mapping of activation tokens to account numbers.

9. The method of claim 7, wherein updating the status of the account number to activate the prepaid card includes updating the status of a plurality of account numbers to activate a plurality of prepaid cards associated with the activation token including the prepaid card.

10. The method of claim 9, wherein the plurality of prepaid cards are packaged within a same packaging.

11. The method of claim 7, further comprising:
receiving, at the prepaid card server, a transaction request including the account number;
updating, by the prepaid card server, a ledger based on the transaction request; and
transmitting, by the prepaid card server, an authorization notification in response to the transaction request.

12. The method of claim 7, further comprising:
receiving, at the prepaid card server, a balance query including the activation token; and
transmitting, by the prepaid card server, in response to the balance query, a response including a balance that is not a balance of the prepaid card.

13. The method of claim 7, further comprising:
receiving, at the prepaid card server, a transaction request including the activation token; and
transmitting, by the prepaid card server, a rejection notification in response to the transaction request.

14. The method of claim 7, further comprising:
receiving, at the prepaid card server, an activation request including the account number;
querying, by the prepaid card server, a database using the account number; and
in response to determining that the account number is associated with an activation token, transmitting, by the prepaid card server, a rejection notification in response to the transaction request.

15. A system comprising:
a prepaid card database storing a plurality of account numbers, a plurality of activation numbers, and a mapping to associate the plurality of account numbers with the plurality of activation numbers; and
a prepaid card server that executes instructions in a non-transitory, computer-readable medium to:
receive an activation request including an activation number associated with a plurality of prepaid cards included in a single packaging;
identify, using the mapping stored in the prepaid card database, account numbers of the plurality of prepaid cards; and
activate the plurality of prepaid cards for use in executing transactions.

16. The system of claim 15, wherein activating the plurality of prepaid cards includes updating a status of the plurality of account numbers of the prepaid cards in the prepaid card database.

17. The system of claim 15, wherein the prepaid card server includes the prepaid card database.

18. The system of claim 15, wherein the prepaid card server executes the instructions to cancel the activation number in response to the plurality of prepaid cards being activated.

19. The system of claim 15, wherein the single packaging conceals the plurality of prepaid cards, and wherein the packaging includes the activation number.

20. The system of claim 1, wherein the covering comprises a packaging within which the prepaid card is packaged.
